(19) United States
(12) Patent Application Publication
(10) Pub. No.: US 2003/0082948 A1
(43) Pub. Date: May 1, 2003

(54) Lighting fixture mounting apparatus

(75) Inventors: Susan Hakkarainen, Doylestown, PA (US); Norman Huhn, Mannheim, PA (US)

Correspondence Address: OSTROLENK FABER GERB & SOFFEN, 1180 AVENUE OF THE AMERICAS, NEW YORK, NY, 100368403

(73) Assignee: Ivalo Lighting Inc.

(21) Appl. No.: 10/254,630

(22) Filed: Sep. 25, 2002

Related U.S. Application Data
(60) Provisional application No. 60/324,888, filed on Sep. 26, 2001.

(51) Int. Cl. H01R 13/60

(52) U.S. Cl. 439/531

(57) ABSTRACT

A mounting device for a lighting fixture includes an adaptor ring which is attachable by screws to an electrical junction box, a cover plate that fits into a central aperture in the adaptor ring to provide a closure for the junction box, and a passage into the junction box for wires from the fixture, a mounting chassis that attaches to the adaptor, at least one gripper on the chassis that is attachable to a supporting member for the fixture, a temporary support member that supports the fixture while wiring connections are made, and a canopy that provides a cover for the adaptor, the chassis, and the junction box.

This application claims priority to provisional application serial number 60/324,888, filed Sep. 26, 2001.

### BACKGROUND OF THE INVENTION

1. Field of the Invention

The present invention relates to a ceiling mounting apparatus for lighting fixtures, and more particularly, to mounting apparatus which can be attached directly to a conventional electrical junction box, and which permits convenient installation and alignment of large and small fixtures, including non-symmetric structures which exhibit unidirectional or unbalanced weight distribution, or fixtures having large canopies.

2. Related Art

A ceiling luminaire or fixture is typically mounted using a horizontally mounted crossbar that is attached to an electrical junction box with screws. The center of the crossbar has a threaded hole into which a fixture nipple such as a threaded hollow rod can be attached. The luminaire itself is attached to this rod using a locking nut. The entire assembly is often covered by an inverted dome or canopy that covers wiring connections made in the junction box and the mechanical mounting components. Several problems must be addressed in designing such mounting assemblies. For example, local electrical codes generally dictate that the volume of air enclosed by the canopy be small so that a fire within the canopy can not easily be sustained. Such code requirements must be met even if design considerations dictate use of large canopies. This should be done in an economical and convenient way.

Even apart from code requirements, existing canopies tend to be quite small and lie close to the ceiling. That sometimes makes installation of large fixtures difficult. This is especially true for longitudinally extended fixtures which must be properly aligned. In such cases, the single-point mounting is often replaced with some type of multi-point mounting. This, in turn, introduces its own set of problems, including the need for a large canopy or multiple small canopies.

In many designs, the wires must be pushed through the nipple so that connections can be made to the wires in the junction box. This can be inconvenient, awkward and unsafe, especially if connections need to be made while at the same time supporting the luminaire in the air. In any event, there is risk of damage to the insulation of the wires from contact with sharp edges of the nipple. Often, a decorative nut is used to attach the luminaire to the threaded rod and also to secure the canopy in place. This, too, can be inconvenient, even for small fixtures.

### SUMMARY OF THE INVENTION

It is accordingly an object of the present invention to provide an improved mounting apparatus for a lighting fixture or luminaire.

Another object of the invention is to provide a luminaire mounting apparatus that allows wire connections to be made inside a small enclosed area that includes an electrical junction box, as required by electrical code while allowing a fairly large canopy to be used, when dictated by design considerations.

It is another object of the invention to provide a luminaire mounting apparatus which permits the luminaire to be conveniently oriented on a single-point mounting and secured in place so that no rotation can occur after installation.

It is a further object of the invention to provide a luminaire mounting apparatus which permits the luminaire to be supported while wire connections are being made.

According to one aspect of the invention, the fixture mounting apparatus comprises first mounting means attachable to an electrical junction box, first cover means that cooperates with the mounting means to provide a closure for the junction box, and to provide a passage into the junction box for wires from the fixture, a second mounting means supported by the first mounting means, the second mounting means including means for securing the second mounting means in a desired alignment relative to the junction box, and attachment means for supporting the fixture in place after assembly, suspension means to support the fixture in place while wiring connections are made, and a second means that provides a cover for the first and second mounting means and the junction box.

According to a second aspect of the invention, the fixture mounting apparatus comprises an adaptor which is attachable to an electrical junction box, a cover plate that cooperates with the adaptor to provide a closure for the junction box, and to provide a passage into the junction box for wires from the fixture, a gripper supported by the adaptor that is attachable to a supporting member for the fixture in place after assembly, a temporary support member that supports the fixture while wiring connections are made, and a canopy that provides a cover for the adaptor, the mounting chassis, and the junction box.

According to the second aspect of the invention, the adaptor comprises an adaptor ring which is attachable to an electrical junction box, and a mounting chassis that attaches to the adaptor ring; the cover plate cooperates with the adaptor ring to provide the closure for the junction box, and the passage into the junction box for the wires from the fixture, the gripper is mounted on the chassis, and the canopy provides a cover for the adaptor ring, the chassis, and the junction box.

Further according to the second aspect of the invention, the cover plate includes resilient fingers which are snap-fitted into a central aperture in the adaptor ring when the cover plate is installed.

Also according to the second aspect of the invention, the canopy is installed on the mounting chassis by means of a spring mechanism attached to the inside of the canopy, and which engages with the mounting chassis.

Further according to the second aspect of the invention, the grippers provide stress relief for the fixture wiring, and ground return continuity.

According to a third aspect of the invention, the chassis is in the form of a U-shaped channel open at the top and the ends, and attached to the adaptor by means of screws which extend through slots in the bottom of the channel.

According to a fourth aspect of the invention, hinged cover plates are provided for the open top of the mounting chassis.

According to a fifth aspect of the invention, the temporary support members are comprised of load bearing wires or chains connected between the adaptor ring and the mounting chassis. Also according to the fifth aspect of the invention, a retaining wire or chain is provided for securing the cover plate to the adaptor to prevent the cover plate from being separated from the rest of the assembly during installation.

According to a sixth aspect of the invention, when the fixture is supported by poles or rods, the grippers are mounted in slots in the chassis to allow the orientation of the poles to be adjusted relative to each other. Also according to the sixth aspect of the invention, the pole gripper includes at least one set screw which engages with a circumferential groove near the top of the pole.

According to a seventh aspect of the invention, a grounding wire is provided between the chassis and the canopy.

According to an eighth aspect of the invention, the mounting chassis may be connected to the adaptor by screws which pass through slots in the chassis which are shaped so the chassis is angularly or translationally adjustable in the plane of the adaptor to allow convenient orientation of the fixture, and positioning relative to the junction box.

According to a ninth aspect of the invention, the chassis mounting screws cooperate with mounting studs which allow the chassis to be tilted relative to the adaptor ring to accommodate an intentionally sloping or an uneven ceiling.

According to a tenth aspect of the invention, for small canopies, the adaptor can also serve as the mounting chassis for the fixture.

Other features and advantages of the present invention will become apparent from the following description of the invention which refers to the accompanying drawings.

### BRIEF DESCRIPTION OF THE DRAWINGS

FIG. 1 is an exploded view of the major elements which comprise the mounting apparatus according to this invention.

FIG. 2 is a top plan view of the adaptor ring.

FIG. 3 is a side elevation of the mounting stud that secures the mounting chassis to the adaptor ring.

FIG. 4 is a subassembly drawing in perspective which shows the adaptor ring, the mounting chassis and the temporary support members.

FIG. 5 is a side view of the subassembly shown in FIG. 4.

FIG. 6 is a perspective end view of one end of the mounting chassis showing a cover, and the grippers for suspension rods or tubes for the fixture.

FIG. 7 is a bottom perspective view of one end of the mounting chassis showing further details of the suspension pole grippers.

FIG. 8 is a view similar to FIG. 7 showing a chassis for use when the fixture is mounted on wire ropes or cables, rather than poles or rods.

FIG. 9 shows a gripper for use with the chassis of FIG. 8.

FIG. 10 is a perspective view of the inside of the canopy showing a canopy mounting spring clip and the attachment of a grounding wire.

### DETAILED DESCRIPTION OF THE INVENTION

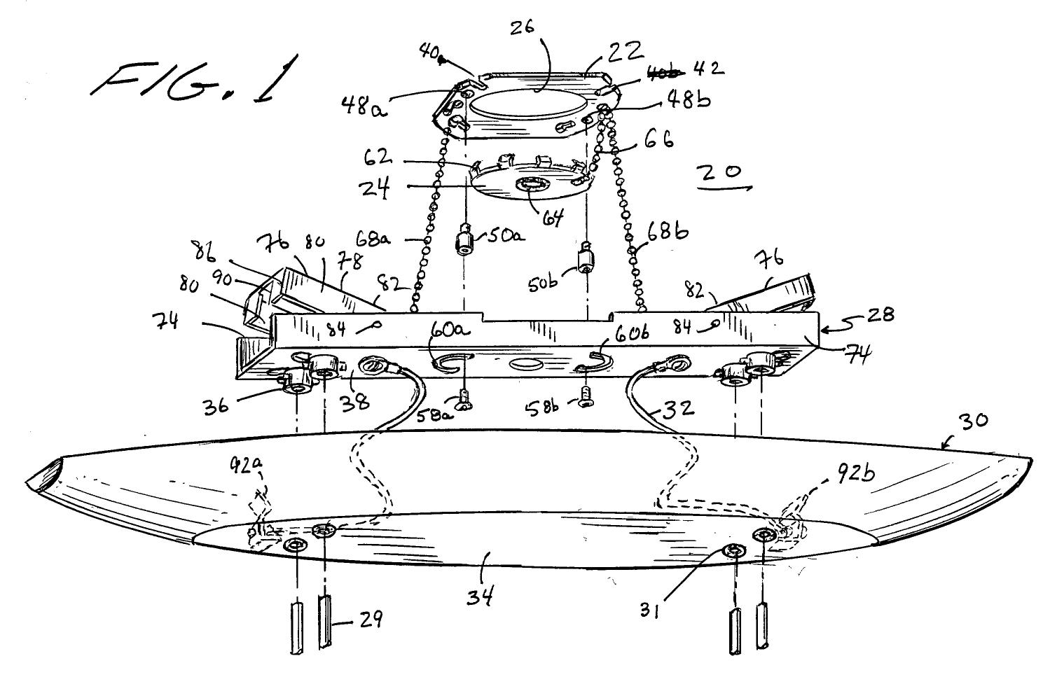

Referring to FIGS. 1-5, the mounting assembly generally denoted at 20 is comprised of an adaptor ring 22 which attaches to a conventional junction box (not shown), a cover plate 24 for a central aperture 26 in adaptor ring 22, a mounting chassis 28 which is adjustably attachable to adaptor ring 22, and a covering canopy 30 which attaches to chassis 28. The lighting fixture is attached to mounting chassis 28 in any suitable or desired fashion, such as by hollow rods or poles 29 which extend through rubber grommeted openings 31 in the bottom 34 of canopy 30, and are secured by suitable grippers 36 extending from the bottom 38 of chassis 28. As will be understood, electrical wires extend from the junction box to the fixture through one or more of the mounting rods.

All the parts described above are preferably made of metal having good electrical conductivity and should be of sufficient strength to safely bear the weight of the fixture and the supporting rods. As will be appreciated, canopy 30 is not load bearing and thus may be made of any material having desired decorative features. If canopy 30 is formed of an electrically conductive material, grounding straps 32 are provided between chassis 28 and the canopy.

The load bearing parts may alternatively be formed of non-metallic materials, in which case, ground connectors between the function box and the fixture must also be provided.

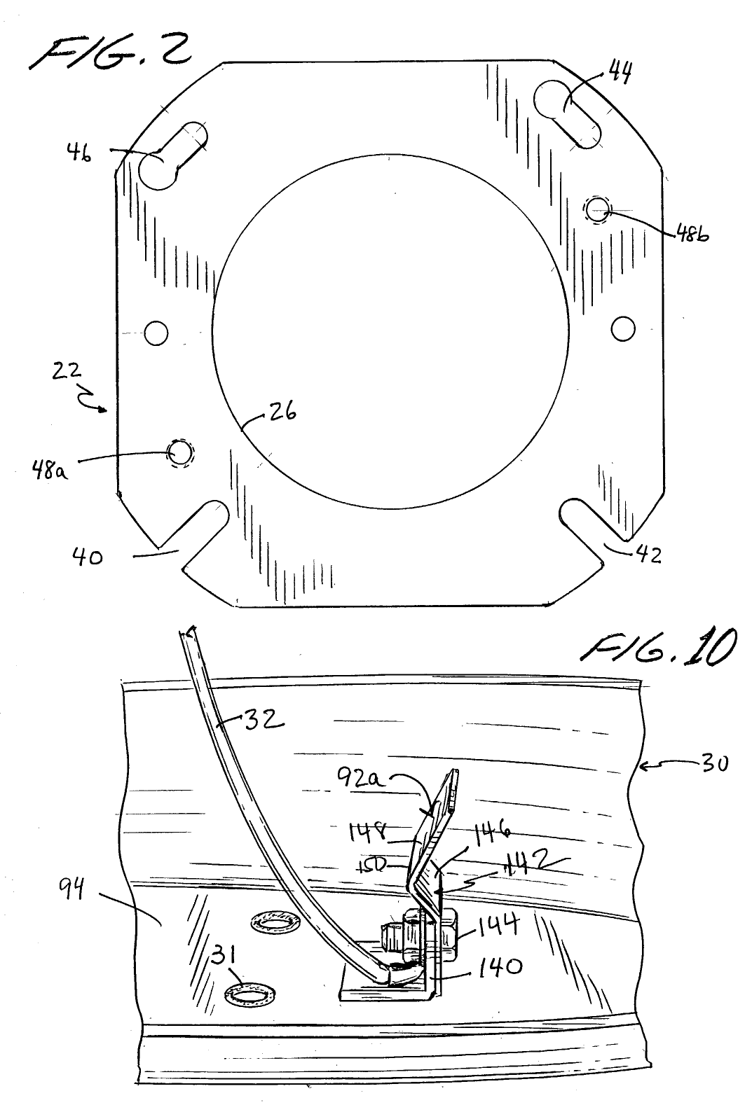

Adaptor ring 22 includes two open radial slots 40 and 42, and respective opposed keyhole slots 44 and 46 (see FIG. 2). Screws received in slots 40 and 44 or 42 and 46 secure adaptor ring 22 to the junction box in a conventional manner. Adaptor ring 22 also includes a pair of diametrically opposed threaded apertures 48a and 48b, which receive chassis mounting studs 50a and 50b. As best shown in FIG. 3, chassis mounting studs 50 are each formed of a body portion 54 having a reduced diameter threaded post 52 at its upper end, and an internally threaded bore 56 at its lower end. Mounting screws 58a and 58b which extend respectively through a pair of arcuate mounting slots 60a and 60b in chassis 28 are received in bores 56 to secure the chassis to adaptor ring 22. This construction permits quick and convenient attachment of the chassis to the adaptor ring, and adjustment of the chassis relative to the walls of the room.

As will be appreciated, the specific shape of slots 60a and 60b determine the extent of adjustability of the mounting chassis, and accordingly, of the fixture and the canopy, relative to the plane of adaptor ring 22. In particular, slots 60a and 60b can be shaped to permit both angular rotation of chassis 28 about a vertical axis, and also translational positioning relative to the junction box. In addition, the length of mounting screws 58a and 58b, and of mounting studs 50a and 50b will permit chassis 28 to be mounted in a tilted position relative to the plane of the adaptor ring. This allows accommodation of sloping ceilings, and also compensation for irregularities in the ceiling near the junction box.

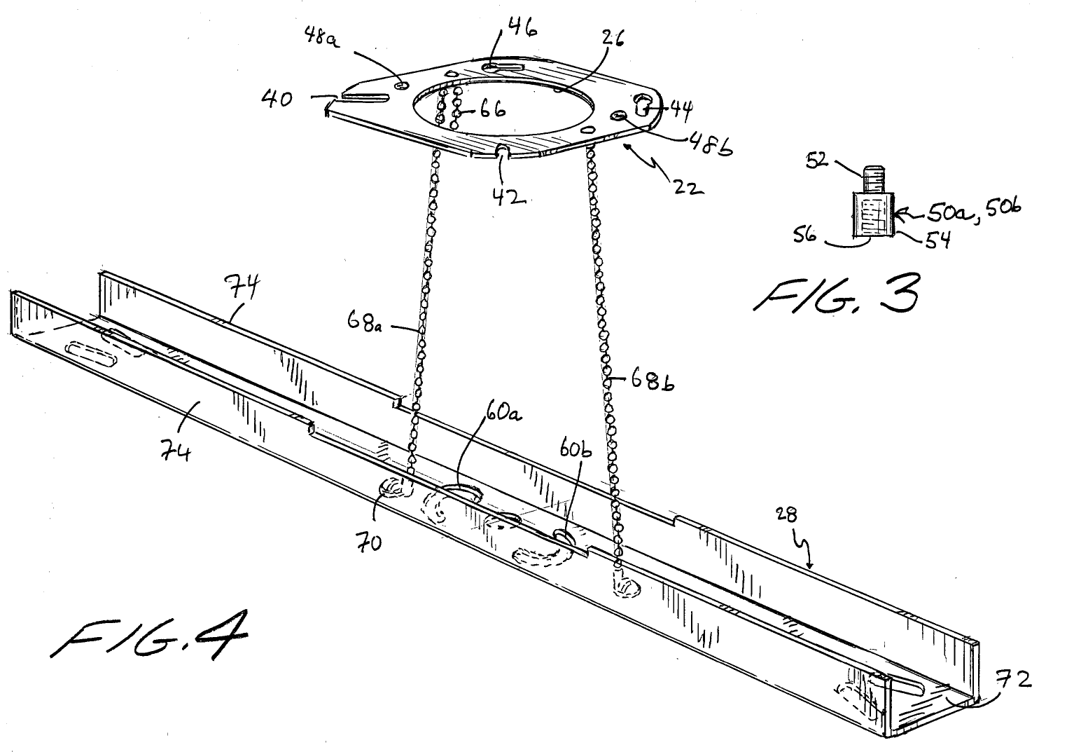

Referring to FIGS. 1 and 4, cover plate 24 includes a plurality of circumferential spring fingers 62 which are resiliently received in adaptor ring central aperture 26 to secure the cover plate to the adaptor ring. One or more rubber grommeted holes 64 in cover plate 24 communicate between the interior 66 of chassis 28 and the interior of the junction box to permit safe passage of the wires for the fixture, and also serves to restrict airflow into the junction box. A retaining wire or chain 66 is attached between adaptor ring 22 and cover plate 24 to prevent the latter from falling to the floor during installation or getting lost on a jobsite.

Likewise, two additional wires or chains 68a and 68b are attached between adaptor ring 22 and chassis 28. These serve as temporary support members for the chassis and the fixture during wiring. As described below, the fixture will typically be attached to chassis 28 before the latter is secured to adaptor ring 22. Accordingly, there may be times during which wires or chains 68 will have to support the weight of the fixture and must therefore be of suitable strength to perform this function. As illustrated in FIGS. 4 and 5, chains 66 and 68a, 68b are terminated with suitable eyes 70 which may be secured by screws and nuts or the like to adaptor ring 22, cover plate 24 and the interior 72 of chassis 28

As will be understood, chassis 28 is suitably shaped and sized for supporting the fixture and canopy 30. As illustrated in FIGS. 1, 4, and 5, chassis 28 is formed of an elongated open-ended generally U-shaped channel defined by a horizontal bottom plate 38 and opposed vertical side plates 74. Chassis 28 may be open at the top, as illustrated in FIG. 4, or may be provided with top pivoting covers 76.

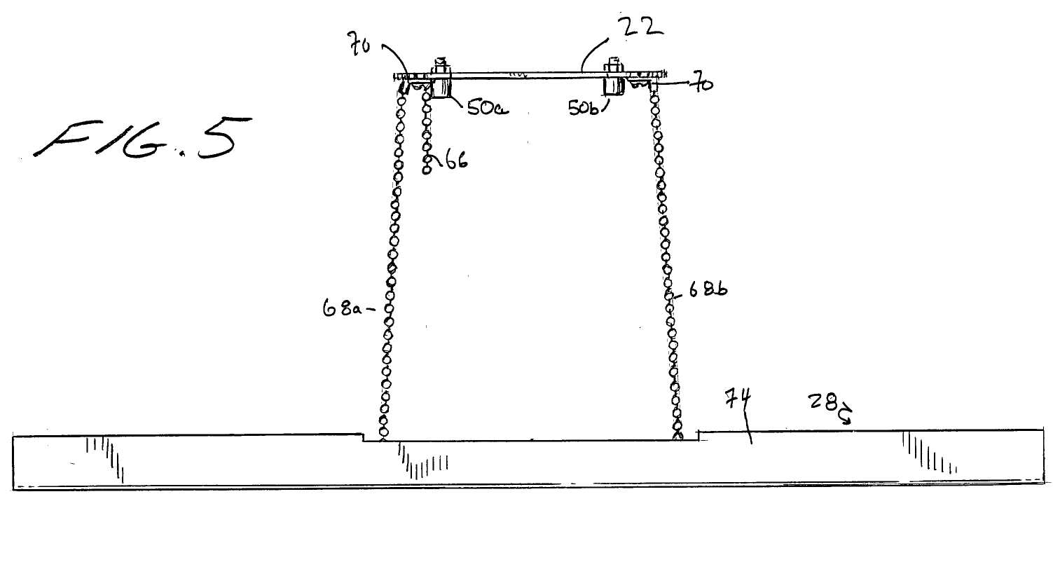

As illustrated in FIGS. 1 and 6, top covers 76 are formed of generally U-shaped inverted channels defined by a horizontal top plate 78 and downwardly depending opposed vertical sides 80. The adjacent central ends 82 of cover side plates 80 are loosely attached by rivets 84 to chassis side plates 74 to permit the covers to pivot up and down during installation. Covers 76 provide a substantially closed protective passage for the wires extending through grippers 36 from the fixture to the point of entry into the junction box through grommeted openings 64 in cover plate 24.

The outer ends 86 of chassis covers 78 are formed of downwardly depending tabs 88 having vertical cutouts 90. These cutouts engage with spring mechanisms 92 secured to the interior surface 94 of canopy 30, as described below in connection with FIG. 10.

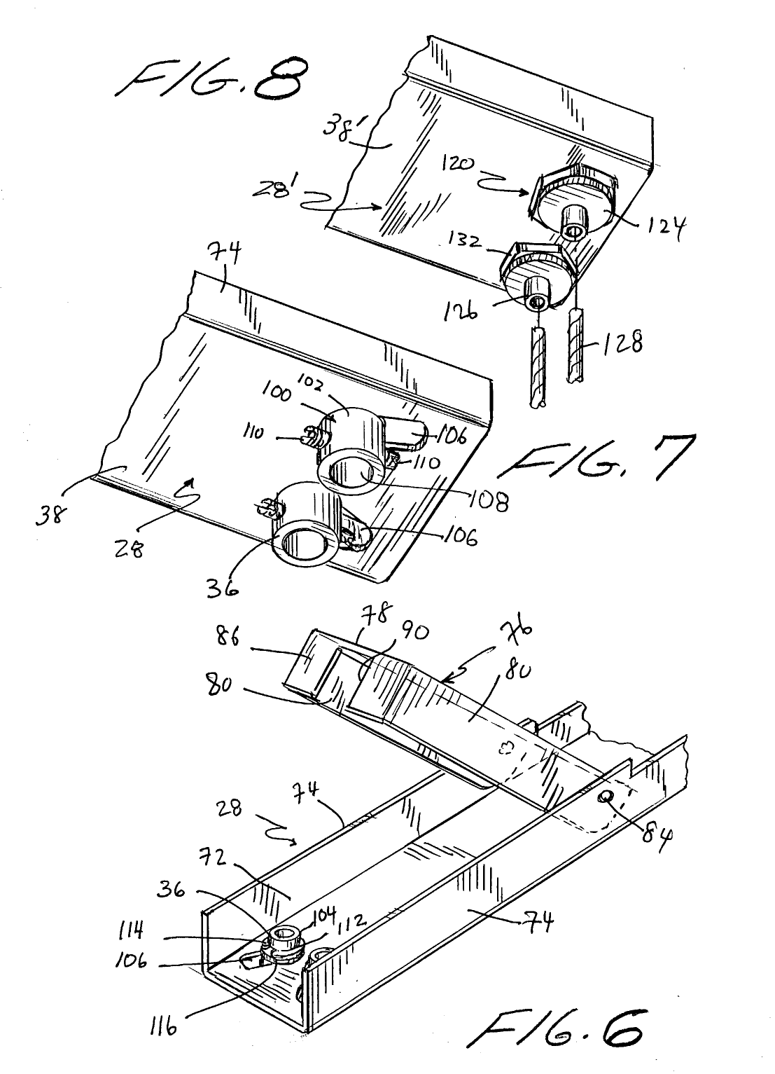

FIGS. 6 and 7 show how grippers 36 are constructed and attached to mounting chassis 28. Any suitable gripper may be employed, but in its preferred form, gripper 36 is comprised of a substantially cylindrical body 100 having a lower portion 102 and upwardly extending reduced diameter portion 104 which fits through an angularly disposed slot 106 in chassis bottom plate 38. The interior 108 of body 100 is sized to receive the ends of the fixture suspension rod or pole 29. One or more radial set screws 110 are provided to firmly engage the ends of the pole after installation. A circumferential groove at the top of pole 29 may also be provided to receive set screws 110 for positive retention of the pole in the gripper.

Reduced diameter upper portion 104 includes a circumferential groove 112 which receives a C-shaped spring clip 114 to secure gripper 38 to mounting chassis 28. One or more spacers 116 installed on upper portion 104 provides a frictional fit in slot 106 to prevent relative motion of the pole after assembly.

As illustrated, the fixture is suspended by four poles, and accordingly, four grippers 36 are required. These are positioned in slots 106 to allow adjustment of the relative orientation of the poles. However, it will be appreciated by those skilled in the art that depending on aesthetic and weight considerations, only two poles may be required. In that case, chassis 28 will be configured with only two slots 106, and only two grippers will be employed. Likewise, only two openings 31 will be provided in canopy 30.

It will also be appreciated by those skilled in the art that a single pair of appropriately sized and positioned slots 106 may be employed to accommodate two or four poles.

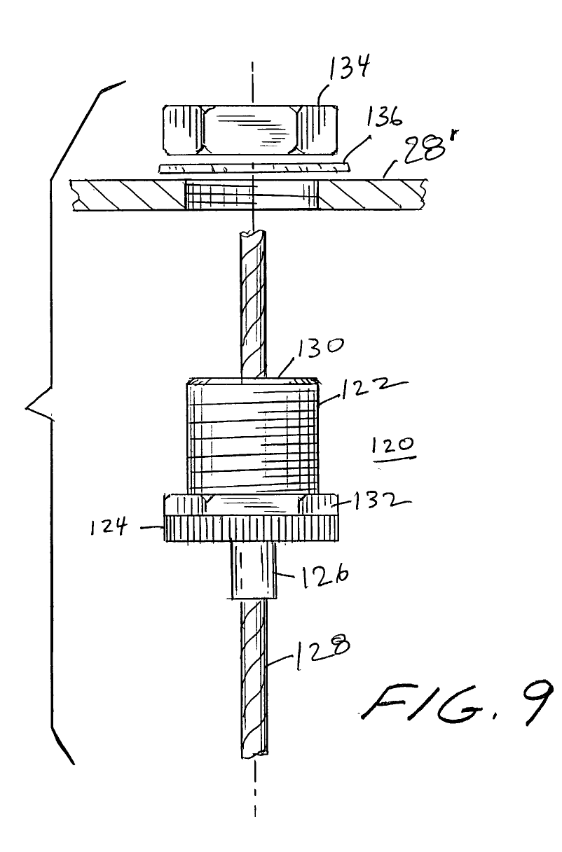

FIGS. 8 and 9 show an alternative embodiment of the mounting chassis, generally denoted at 28′ which may be used if the fixture is suspended by wire ropes or cables. A preferred form of such a cable is shown in U.S. patent application Serial No. 60/395,818, filed Jul. 11, 2002, entitled COMBINED SUSPENSION CABLE AND ELECTRICAL CONDUCTOR. In the embodiment of FIGS. 8 and 9, grippers specifically designed for use with stranded wire suspension cables for lighting fixtures, manufactured by Arakawa Hanging systems of 1020 SE Harrison, Portland Oreg., may be employed. As illustrated, gripper 120 comprises a threaded body 122 terminating at one end in an enlarged shoulder 124. A tubular extension 126 protrudes from shoulder 124. A cable 128 passes through tubular extension 126 and out through the opposite end 130 of body 122. Gripper 120 may be installed with the upper surface shoulder 124 resting against chassis bottom plate 38′, or, as illustrated, with an intervening spacer nut 132 and is secured in place by a nut 134 and a lock washer 136.

The Arakawa gripper described above employs spring biased gripper balls (not shown) which surround cable 128 within a housing defined by body 122 and lock the cable in place against the weight of the suspended fixture. Tubular extension 126 is movable upwardly against the biasing spring to release the pressure of the balls. This allows cable 128, which fits loosely within tubular extension 126, to be repositioned in the “downward” direction (i.e., with gravity). The position of the cable may be adjusted in the upward direction (i.e., against gravity) simply by pulling it up through the housing.

Canopy 30 is preferably designed to match or complement the design of the fixture, and may accordingly be made in a variety of shapes. For convenient assembly and disassembly, and better appearance, however, canopy 30 is preferably designed for attachment to opposite ends of chassis 28 by spring mechanisms 92a and 92b.

Spring mechanism 92b, illustrated in FIG. 10, is formed of a bracket 140 suitably secured to the inner surface 94 of canopy 30. An upwardly extending spring finger 142 attached by a screw 144 to bracket 140 includes an inwardly slanted portion 146 and an outwardly slanted portion 148. When installed, the horizontally extending line of intersection 150 between slanted portions 146 and 148 snaps over the ends of chassis bottom plate 38 to releasably secure the canopy in place.

Also, as illustrated in FIGS. 1 and 10, grounding wires 32 may also be connected to canopy 30 by screws 14.

To install a pole-mounted luminaire using the mounting device according to this invention, wires attached to the fixture and run through the mounting poles 29 (if not factory-installed), and the poles are attached to the fixture. Canopy 30 is then pushed down slightly onto poles 29, the upper ends of the poles are inserted into grippers 36, and set screws 110 are tightened. Holding the chassis with one hand, adaptor ring 22 is then fitted onto pre-installed screws on the junction box (using either slots 40, 44 or 42, 46 as dictated by the configuration of the junction box) and the screws are tightened to secure the adaptor ring. During these steps, chains 66, and 68a and 68b support chassis 28 and cover plate 24 as necessary.

Once the adaptor ring has been secured, chassis 28 is attached to mounting studs 50a, 50b using screws 58a, 58b, the wires are run through grommeted hole 64 in cover plate 24, the wiring connections are made the junction box, and cover 24 is snapped in place on adaptor ring 22. After chassis 28 and poles 29 are properly positioned by use of screws 58a and 58b, slots 60a and 60b, covers 76 are closed, and canopy 30 is snap-fitted onto the ends of chassis 28 to complete the installation.

For a cable-mounted fixture, the installation is essentially the same, except that the length of the cables is adjusted to level the fixture by manipulating extensions 126 on grippers 120 before the canopy is installed.

In the foregoing description, the adaptor ring and the mounting chassis have been described as separate parts. For small canopies and/or fixtures, it may be possible to combine the functions of these parts into a single adaptor plate. In such a construction, the grippers would be mounted on the adaptor plate in slots providing the desired angular, transnational, and tilting adjustability, and the temporary support members could be connected to the canopy to support the fixture during installation.

Although the present invention has been described in relation to particular embodiments thereof, many other variations and modifications and other uses will become apparent to those skilled in the art. It is intended, therefore, that the present invention be limited not by the specific disclosure herein, but only by the appended claims.

What is claimed is:

1. A mounting device for a lighting fixture comprising:
an adaptor which is attachable to an electrical junction box for supporting the fixture;
a gripper supported by the adaptor that is attachable to a supporting member for the fixture;
a temporary support member that supports the fixture while wiring connections are made; and
a canopy that provides a cover for the adaptor, and the junction box.

2. A mounting device as described in claim 1, wherein:
the adaptor comprises:
an adaptor ring which is attachable to an electrical junction box;
a mounting chassis that attaches to the adaptor ring; and
a cover plate cooperates with the adaptor ring to provide the closure for the junction box, and the passage into the junction box for the wires from the fixture;
the gripper is mounted on the chassis; and
the canopy provides a cover for the adaptor ring, the cover plate, the chassis, and the junction box.

3. A mounting device as described in claim 2, wherein the chassis is a U-shaped channel open at the top and the ends, and is attached to the adaptor by at least one screw which extends through a slot in the bottom of the channel.

4. A mounting device as described in claim 3, further including a cover for the open top of the mounting chassis.

5. A mounting device as described in claim 4, wherein the chassis cover is comprised of two inverted U-shaped channels extending from approximately the mid-point of the chassis to the respective ends thereof, the cover channels having respective tops and opposed sides, the sides being pivotally attached to the chassis to permit the covers to be opened and closed.

6. A mounting device as described in claim 2, further including a movable cover for the chassis.

7. A mounting device as described in claim 2, wherein the temporary support member is comprised of flexible load bearing member connected between the adaptor ring and the chassis.

8. A mounting device as described in claim 2, wherein the fixture is supported by a plurality of poles, and grippers for each pole are adjustably mounted on the chassis to allow the orientation of the poles to be varied relative to each other.

9. A mounting device as described in claim 8, wherein the grippers each include a radial set screw which engages with a circumferential groove near the tops of the poles.

10. A mounting device as described in claim 2, wherein the fixture is to be supported by a plurality of cables, and grippers for each cable are operable to allow vertical movement of the cables therein to level the fixture.

11. A mounting device as described in claim 1, wherein the adaptor is angularly adjustable to a desired alignment relative to the junction box.

12. A mounting device as described in claim 1, wherein the adaptor is translationally adjustable to a desired position relative to the junction box.

13. A mounting device as described in claim 1, wherein the adaptor is tiltably adjustable to a desired position relative to the junction box.

14. A mounting device as described in claim 1, wherein the adaptor includes:
a generally ring-shaped portion having a central aperture through which the interior of a junction box is accessible when the adaptor is installed; and
a removable cover plate for the central aperture.

15. A mounting device as described in claim 14, wherein the cover plate includes resilient elements which snap-fit into the central aperture.

16. A mounting device as described in claim 15, wherein the cover plate includes at least one opening for admitting wires from the fixture into a junction box.

17. A mounting device as described in claim 1, wherein the adaptor includes a generally ring-shaped portion, and opposed slots engageable with screws protruding from a junction box.

18. A mounting device as described in claim 1, wherein the canopy includes a member on the inside thereof which resiliently engages with the adaptor when the canopy is installed.

19. A mounting device as described in claim 1, wherein the gripper provides stress relief for the fixture wiring, and ground return continuity.

20. A mounting device as described in claim 1, wherein the temporary support member is comprised of a flexible load bearing member extending from the adaptor.

21. A mounting device as described in claim 14, further including a retaining member that secures the cover plate to the adaptor to prevent the cover plate from being separated from the rest of the assembly during installation.

22. A mounting device as described in claim 1, wherein the fixture is supported by a pole, and the gripper is mounted in a slot to allow the orientation of the pole to be adjusted.

23. A mounting device as described in claim 22, wherein the gripper includes a radial set screw which engages with a circumferential groove near the top of the pole.

24. A mounting device as described in claim 1, further including a grounding wire connected between the adaptor and the canopy.

25. A mounting device for a luminaire comprising:
first mounting means attachable to an electrical junction box;
first cover means that cooperates with the mounting means to provide a closure for the junction box, and to provide a passage into the junction box for wires from the fixture;
a second mounting means supported by the first mounting means, the second mounting means including:
means for securing the second mounting means in a desired aligmnent relative to the junction box;
attachment means for supporting the fixture in place after assembly;
suspension means to support the fixture in place while wiring connections are made; and
second cover means for the first and second mounting means and the junction box.
